(19) United States
(12) Patent Application Publication
(10) Pub. No.: US 2010/0025467 A1
(43) Pub. Date: Feb. 4, 2010

(54) STRUCTURE FOR READING THE INFORMATION OF THE RFID TAGS

(76) Inventor: Joseph G. Leone, Mount Airy, MD (US)

Correspondence Address: STITES & HARBISON PLLC, 1199 NORTH FAIRFAX STREET, SUITE 900, ALEXANDRIA, VA, 22314, US

(21) Appl. No.: 12/442,216

(22) PCT Filed: Sep. 20, 2007
(86) PCT No.: PCT/IB07/53813

§ 371 Date: Aug. 31, 2009

Related U.S. Application Data
(60) Provisional application No. 60/826,285, filed on Sep. 20, 2006.

(51) Int. Cl. G06K 7/08; G06K 13/00

(52) U.S. Cl. 235/439; 235/475

(57) ABSTRACT

A table is disclosed which incorporates one or more antenna for reading RFID tags attached to articles which are on the table. The table has legs which enables its height to be adjusted either to bring it level with other components such as conveyor belts in a materials handling line. The table itself can include a conveyor belt. In one form the table has top and bottom panels with a gap therebetween in which the antenna are located. In another form the antenna are embedded in a resin plate which constitutes the table's top.

### FIELD OF THE INVENTION

THIS INVENTION relates to a structure for reading the information on RFID tags.

### BACKGROUND TO THE INVENTION

Radio Frequency Identification (RFID) has become an important way of “tagging” articles. Use of such tags facilitates the performance of a multitude of tasks. Examples are checking inventories, locating a specific article amongst a large number of articles, and checking that a packed container has in it the correct articles without unpacking the container.

Tags currently in use are of two main types, namely passive and active. Active tags have their own power source and transmit the data on them continuously whereas passive tags are powered by electromagnetic radiation emitted by a reader. The passive tag then responds, transmitting back to the reader the data stored therein.

A specific area which currently gives rise to difficulty is determining with acceptable accuracy which tagged items are in a container without opening the container.

### BRIEF DESCRIPTION OF THE INVENTION

According to the present invention there is provided a table having embedded therein one or more antenna for reading tags which are above the table.

The table can comprise a top panel and a bottom panel with one or more antenna between the panels. The or each antenna is sensitive to tags above the table. The table can have a metal shield placed to allow an area around the table to be the focus for reading RFID tags. The table can also have a metal base plate below the antenna thereby to inhibit reception by the antenna of signals from tags not above the table.

The table can comprise a unit constituting one terminal of a data link for connecting the antenna to information processing means. The data link can be a cable, a radio frequency connection, a laser link or an infrared link. The table can also include electronic data storage means which receives the information read from the tags which are detected by the antenna and stores the information for later retrieval. The table can further include visual readouts and/or lights, including LCD displays, for indicating to the operator the status of the tag that has been read.

The table can include legs and the legs can be of adjustable height to enable it to be positioned close to the bottom surface of a conveyer belt. Adjustment of the legs also enables the top surface of the table to be brought into horizontal alignment with another surface so that articles can readily be transferred between the table and the other surface. The other surface could be part of a conveyer belt thereby allowing articles to be transferred from the conveyer belt to the table for the tags to be read and then transferred back to the conveyer belt.

In a specific embodiment the table can include a conveyer belt which enables the table to be incorporated into a line along which tagged articles move, there being conveyer belts both upstream and downstream of the table for feeding articles to the table and carrying articles away from the table.

The table can comprise a plurality of side-by-side patch antenna and a control system for activating the antenna in sequence. The control system is preferably of the multiplex type whereby each antenna acts alternately as a transmitter and receiver, and each antenna is activated in sequence. Alternatively, the antenna system may be of the bistatic type having separate transmit and receive antenna.

### BRIEF DESCRIPTION OF THE DRAWINGS

For a better understanding of the present invention, and to show how the same may be carried into effect, reference will now be made, by way of example, to the accompanying drawings in which:

FIG. 1 is a pictorial view of a table;

FIG. 2 is a top plan view of the table with its cover sheet removed;

FIG. 3 is a plan view of a patch antenna, and

FIG. 4 is a section illustrating a further form of table.

### DETAILED DESCRIPTION OF THE DRAWINGS

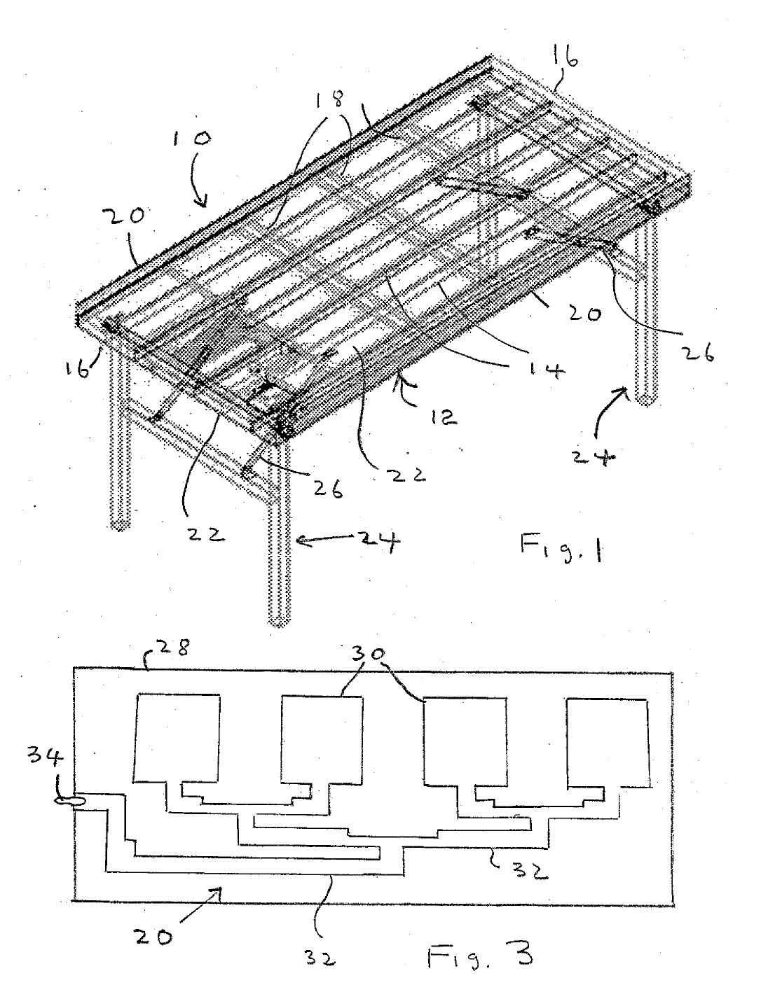

Referring firstly to FIG. 1, the metal framework of the table 10 in accordance with the present invention is shown. The framework comprises a rectangular surround 12 and longitudinal ribs 14 which extend the full length of the table. The ribs are secured at each end thereof to the transverse end members 16 of the surround 12. Transverse ribs 18 span between the longitudinal side members 20 of the surround 12.

The surround 12 and ribs 18 can comprise lengths of box section steel and the longitudinal ribs can be of I-section steel. The construction of the grid of ribs is chosen so that it has sufficient strength to support heavy packages placed on the table. Frameworks of any construction can be used provided they are of sufficient strength.

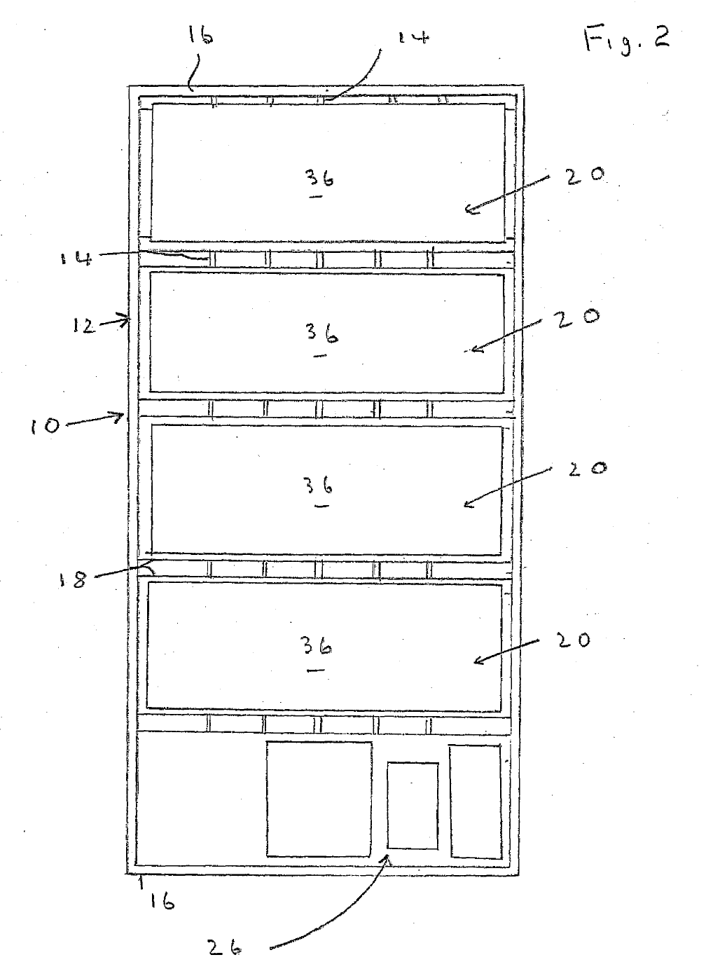

Between the ribs 18 there are transverse supports in the form of angles arranged with their horizontal flanges protruding from the lower edges of their vertical flanges. Patch antenna 20 (FIG. 2), which will be described hereafter, are supported by the horizontal flanges.

The bottom of the framework is closed by a metal sheet 22.

Leg structures 24 extend downwardly from the framework. The leg structures 24 can pivot about horizontal axes below the framework between the extended position shown in FIG. 1 and a stored position in which they lie against the underside of the sheet 22.

The leg structures 24 further include inclined braces 26 which, as the leg structures are moved between their extended and stored positions, slide along guides on the underside of the sheet 22. The braces 26 lock into position when the leg structures 24 are extended.

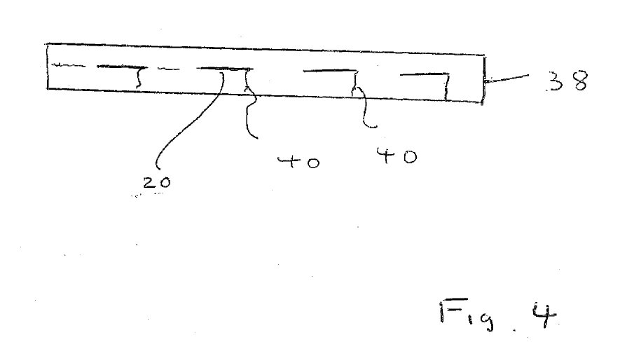

The framework provides, in the illustrated embodiment, five wells. Four of the wells receive patch antenna 20 as shown in FIG. 3 and the remaining well receives a control system and power supply generally indicated at 26. Each well is surrounded by metal components and their bases are closed by the sheet 22. Consequently each antenna is only sensitive to tags that are above it. The number of wells can be increased to more than five or decreased to less that five.

Each patch antenna 20 comprises an electrically insulating board 28 carrying four antenna designated 30. The antenna 30 are connected by electrically conductive strips 32 to a terminal 34.

The antenna 20 are placed in their respective wells with their edges supported by the horizontal flanges of the angles.

Rectangular cover sheets 36 are then secured to the transverse ribs 18 to enclose the patch antenna and an upper table top (not shown) of a synthetic plastics material is secured to the surround 12 thereby to provide a working surface.

The patch antenna can operate in a multiplexing mode, alternately transmitting and receiving. The four patch antenna 20 are activated in sequence by the control system 26 which also includes a communication terminal for transferring data between, for example, a remote data storage computer and a data processing unit forming part of the control system.

It is also possible for some of the patch antenna to be dedicated signal transmitters and others to be dedicated signal receivers.

In the form illustrated in FIG. 4 the table top is constituted by a resin plate 38 which has the antenna 20 embedded in it. Electrical connections to the antenna are shown at 40. The plate 38 is formed by placing a first layer of resin in a mould, placing the antenna and the connections on the resin layer, and then covering the antenna and connections by an upper layer of resin which bonds to the lower layer.

1. A table having embedded therein one or more antenna for reading tags which are above the table.

2. A table as claimed in claim 1 and which comprise a top panel and a bottom panel with one or more antenna between the panels.

3. A table as claimed in claim 1 and including a metal shield placed to allow an area around the table to be the focus for reading RFID tags.

4. A table as claimed in claim 1 and including a metal base plate below the antenna thereby to inhibit reception by the antenna of signals from tags not above the table.

5. A table as claimed in claim 1 and comprising a unit constituting one terminal of a data link for connecting the antenna to information processing means.

6. A table as claimed in claim 5, wherein the data link is selected from a cable, a radio frequency connection, a laser link or an infrared link.

7. A table as claimed in claim 1 and including electronic data storage means which receives the information read from the tags which are detected by the antenna and stores the information for later retrieval.

8. A table as claimed in claim 1 and including visual readouts and/or tell tale lights for indicating to the operator the status of the tag that has been read.

9. A table as claimed in claim 1 and which includes legs of adjustable height to enable it to be positioned close to the bottom surface of a conveyer belt.

10. A table as claimed in claim 1 and comprising a plurality of side-by-side patch antenna and a control system for activating the antenna in sequence.

11. A table as claimed in claim 10, wherein the control system is of the multiplex type whereby each antenna acts alternately as a transmitter and a receiver, and each antenna is activated in sequence.

12. A table as claimed in claim 10, and including, the antenna system of the bistatic type having separate transmit and receive antenna.

13. A table as claimed in claim 1 and including a conveyer belt which enables the table to be incorporated into a line along which tagged articles move.

14. An installation comprising a table as claimed in claim 13 and conveyer belts both upstream and downstream of the table for feeding articles to the table and carrying articles away from the table.
